(19) United States
(12) Patent Application Publication
(10) Pub. No.: US 2020/0029659 A1
(43) Pub. Date: Jan. 30, 2020

(54) WRISTBAND FOR REPLACING A WRISTBAND OF AN EXISTING WATCH

(71) Applicant: Harp Gahunia, Markham (CA)

(72) Inventor: Harp Gahunia, Markham (CA)

(21) Appl. No.: 16/048,306

(22) Filed: Jul. 29, 2018

(51) Int. Cl. A44C 5/00; G04G 19/00

(52) U.S. Cl. CPC A44C 5/00; G04G 19/00

(57) ABSTRACT

A watchband for replacing a wristband of an existing watch is a watchband designed with a power supply for supplying power to a smart watch. The band has a USB port and an inductive power transfer device to power the watch.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of wristwatches and more specifically relates to a wristband for replacing a wristband of an existing watch.

### 2. Description of the Related Art

In recent years, technology has developed that allows electronic devices to become increasingly smaller as time goes by. In addition to becoming smaller, electronic devices are being combined for convenience. Today, computers, music players, televisions, calculators, watches, calendars, cameras, video cameras, telephones, and GPS devices to name a few, are being combined to produce multifunctional electronic devices and the single function electronic devices are gradually disappearing. The cell phone now takes the place of many of the aforementioned electronic devices because of its multi-functionality. The trend is not slowing down though. The progression of new innovations stemming from the continual advancements in technology is pressuring manufacturers to continue developing smaller and more convenient devices. The wristwatch, once thought to be on its way to obsoletion, is now being focused on to incorporate as many of the above mentioned functions as can fit into the watch casing. As progress is made, there are more and more programs and electronic circuits that consume power being put into watches. The problem is that the batteries for supplying power to the watches are not keeping pace with the advancements in functionality. A solution is needed to reduce down time for the devices.

Ideally, a watch battery should provide enough stored power over a long duration of time to power the device, and yet, would operate reliably and be manufactured at a modest expense. Thus, a need exists for a reliable wristband for replacing a wristband of an existing watch to avoid the above-mentioned problems.

### BRIEF SUMMARY OF THE INVENTION

In view of the foregoing disadvantages inherent in the known wristwatches art, the present invention provides a novel wristband for replacing a wristband of an existing watch. The general purpose of the present invention, which will be described subsequently in greater detail, is to provide enough stored power over a long duration of time to power the device.

A wristband for replacing a wristband of an existing watch comprises an elongated main body having a proximal end and a distal end with the main body forming an interior volume, a power supply located within the interior volume of the main body that is adapted to provide power to the existing watch when connected thereto, a charging port electrically attached to the power supply and to the main body that allows power to transfer thereto by releasably attaching to a power cable and allowing power to transfer therethrough, a first attachment member attached to the proximal end of the elongated main body that is electrically connected to the power supply and is adapted to releasably attach to a first portion of the existing watch, and to transfer electric power from the power supply to the existing watch, and a second attachment member, a second attachment member is attached to the distal end of the elongated main body and is electrically connected to the power supply to transfer electric power from the power supply to the existing watch and to releasably attach to a second portion of the existing watch.

The power supply is formed as at least one rechargeable battery and there be as many as four rechargeable batteries electrically interconnected to one another. The elongated main body is preferably formed having a C-shape. The first attachment member and the second attachment member are formed as releasable lock tabs.

A USB power cable is adapted to releasably connect with the charging port and transfer electric power thereto, and the charging port is formed as a USB charging port adapted to releasably receive the USB power cable and allow electric power to transfer from the USB power cable and flow into the power supply.

An indicator light attached to the main body is electrically connected to the power supply and is adapted to alert a user that power is being transferred to the existing watch.

An improved smart watch may comprise a watch member having a housing that includes a first portion adapted to releasably connect with a proximal end of a wristband and allow electric power to pass therethrough, and a second portion spaced from the first portion that is adapted to releasably connect with a distal end of a wristband and allow electric power to pass therethrough, an interior volume that houses a time keeping mechanism that is attached to the housing, at least one battery member located within the interior volume of the housing that is electrically connected to the first and second portions and is electrically connected to the time keeping mechanism, and a removable wristband having an elongated main body including a proximal end, a distal end, and a first attachment member located at the proximal end and adapted to releasably attach to the first portion of the watch member, and a second attachment member located at the distal end and adapted to releasably attach to the second portion of the watch member. The elongated main body is preferably formed having a C-shape. The wristband is replaceable by an identical wristband when necessary.

The main body forms an interior volume containing a power supply that is adapted to provide power to the battery member of the watch member when connected thereto. A charging port is attached to the main body and is adapted to releasably attach a power cable thereto and allow power to transfer therethrough. The charging port is electrically attached to the power supply and is adapted to allow power to transfer thereto. The power supply is formed as at least one rechargeable battery but there may be as many as four rechargeable batteries electrically interconnected to one another.

A USB power cable is adapted to releasably connect with the charging port and transfer electric power thereto. The charging port is formed as a USB charging port adapted to releasably receive the USB power cable and allow electric power to transfer from the USB power cable and flow into the power supply. An indicator light is attached to the main body, is electrically connected to the power supply, and is adapted to alert a user that power is being transferred to the watch member. The first attachment member and the second attachment member are formed as releasable lock tabs.

The time keeping mechanism includes a computer processor and a display screen and the watch member is a smart watch member. The display screen may include touch-screen technology in some embodiments and may not include touch-screen technology in other embodiments.

The present invention holds significant improvements and serves as a wristband for replacing a wristband of an existing watch. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a wristband for replacing a wristband of an existing watch, constructed and operative according to the teachings of the present invention.

FIG. 1 shows a perspective view illustrating a wristband for replacing a wristband of an existing watch member according to an embodiment of the present invention.

FIG. 2 is a perspective view illustrating the wristband for replacing a wristband of an existing watch member according to an embodiment of the present invention of FIG. 1.

FIG. 3 is a side elevation view illustrating the wristband for replacing a wristband of an existing watch member according to an embodiment of the present invention of FIG. 1.

FIG. 4 a perspective view illustrating the wristband for replacing a wristband of an existing watch member with the power supply removed according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a wristwatches and more particularly to a wristband for replacing a wristband of an existing watch as used to improve the length of time between recharges.

Generally speaking, watchband for replacing a wristband of an existing watch is a watchband designed with a power supply for supplying power to a smart watch. The band has a USB port and an inductive power transfer device to power the watch.

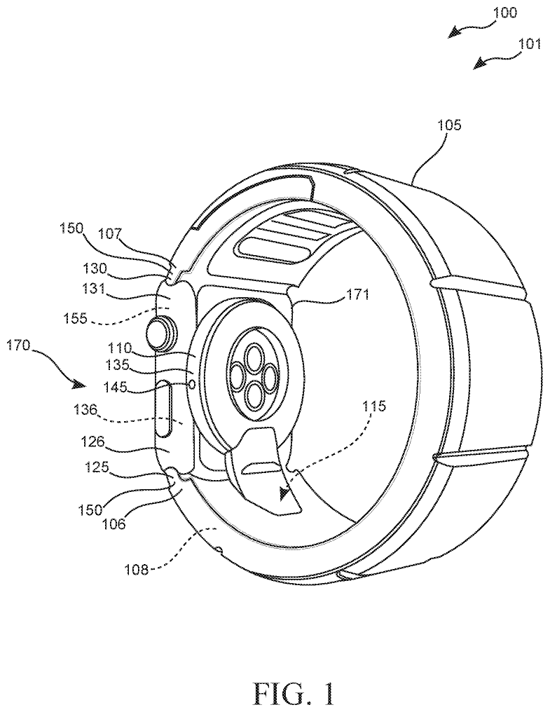

Referring to the drawings by numerals of reference there is shown in FIG. 1, a perspective view illustrating wristband 100 for replacing a wristband of an existing watch member 170 according to an embodiment of the present invention.

Wristband 100 for replacing a wristband of an existing watch member 170 comprises elongated main body 105 having proximal end 106 and distal end 107 with elongated main body 105 forming interior volume 108, power supply 110 located within interior volume 108 of elongated main body 105 that is adapted to provide power to the existing watch member 170 when connected thereto, charging port 115 electrically attached to power supply 110 and to elongated main body 105 that allows power to transfer thereto by releasably attaching to power cable 120 and allowing power to transfer therethrough, first attachment member 125 attached to proximal end 106 of elongated main body 105 that is electrically connected to power supply 110 and is adapted to releasably attach to first portion 126 of the existing watch member 170, and to transfer electric power from power supply 110 to the existing watch member 170, and second attachment member 130, second attachment member 130 is attached to distal end 107 of elongated main body 105 and is electrically connected to power supply 110 to transfer electric power from power supply 110 to the existing watch member 170 and to releasably attach to second portion 131 of the existing watch member 170.

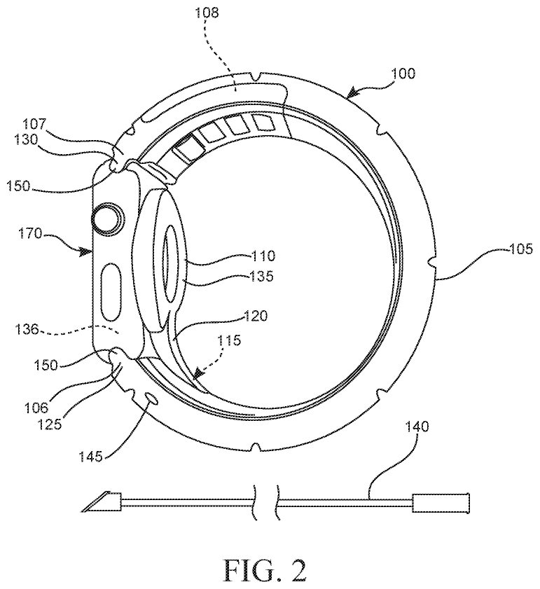

Referring now to FIG. 2, is a perspective view illustrating wristband 100 for replacing a wristband of an existing watch member 170 according to an embodiment of the present invention of FIG. 1.

Power supply 110 is formed as at least one rechargeable battery 135 and there may be as many as four rechargeable battery(s) 135 electrically interconnected to one another. Elongated main body 105 is preferably formed having a C-shape. First attachment member 125 and second attachment member130 are formed as releasable lock tabs 150.

USB power cable 140 is adapted to releasably connect with charging port 115 and transfer electric power thereto, and charging port 115 is formed as a USB charging port 115 adapted to releasably receive USB power cable 140 and allow electric power to transfer from USB power cable 140 and flow into power supply 110.

Indicator light 145 attached to elongated main body 105 is electrically connected to power supply 110 and is adapted to alert a user that power is being transferred to the existing watch member 170.

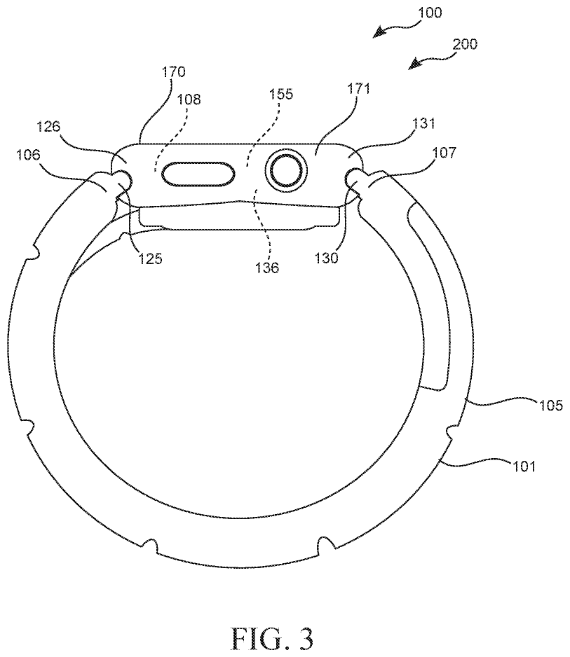

Referring now to FIG. 3, is a side elevation view illustrating wristband 100 for replacing a wristband of an existing watch member 170 according to an embodiment of the present invention of FIG. 1.

Improved smart watch 200 may comprise watch member 170 having housing 171 that includes first portion 126 adapted to releasably connect with proximal end 106 of wristband 100 and allow electric power to pass therethrough, and second portion 131 spaced from first portion 126 that is adapted to releasably connect with distal end 107 of wristband 100 and allow electric power to pass therethrough, interior volume 108 that houses time keeping mechanism 155 that is attached to housing 171, at least one battery member 136 located within interior volume 108 of housing 171 that is electrically connected to first portion 126 and second portion 131 and is electrically connected to time keeping mechanism 155, and removable wristband 101 having elongated main body 105 including proximal end 106, distal end 107, and first attachment member 125 located at proximal end 106 and adapted to releasably attach to first portion 126 of watch member 170, and second attachment member 130 located at distal end 107 and adapted to releasably attach to second portion 131 of watch member 170. Elongated main body 105 is preferably formed having a C-shape. Wristband 100 is replaceable by an identical wristband 100 when necessary.

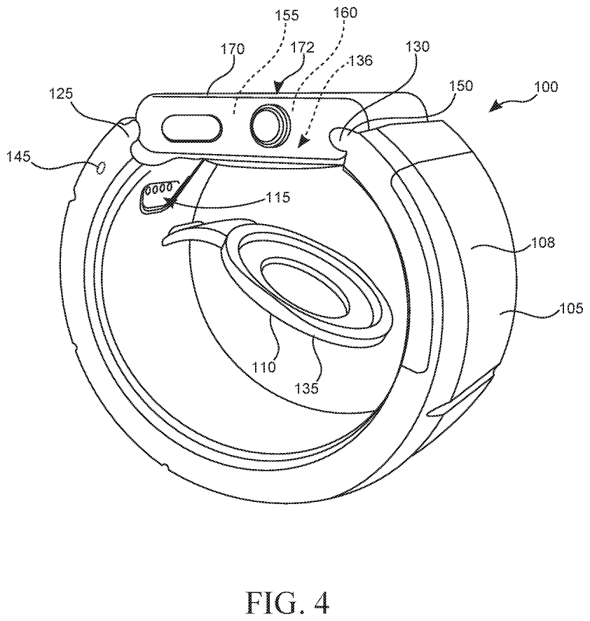

Referring now to FIG. 4, showing a perspective view illustrating wristband 100 for replacing a wristband of an existing watch member 170 with power supply 110 removed according to an embodiment of the present invention of FIG. 1.

Elongated main body 105 forms interior volume 108 containing power supply 110 that is adapted to provide power to battery member 136 of watch member 170 when connected thereto. Charging port 115 is attached to elongated main body 105 and is adapted to releasably attach power cable 120 thereto and allow power to transfer therethrough. Charging port 115 is electrically attached to power supply 110 and is adapted to allow power to transfer thereto. Power supply 110 is formed as at least one rechargeable battery 135 but there may be as many as four rechargeable battery(s) 135 electrically interconnected to one another. USB power cable 140 is adapted to releasably connect with charging port 115 and transfer electric power thereto. Charging port 115 may be formed as a USB charging port 115 adapted to releasably receive USB power cable 140 and allow electric power to transfer from USB power cable 140 and flow into power supply 110. Indicator light 145 is attached to elongated main body 105, is electrically connected to power supply 110, and is adapted to alert a user that power is being transferred to watch member 170. First attachment member 125 and second attachment member130 are formed as releasable lock tabs 150.

Time keeping mechanism 155 includes computer processor 160 and display screen 172 and watch member 170 is a smart watch member 170. Display screen 172 may include touch-screen technology in some embodiments and may not include touch-screen technology in other embodiments.

Wristband for replacing a wristband of an existing watch 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A wristband for replacing a wristband of an existing watch, comprising:
an elongated main body including:
a proximal end; and
a distal end;
wherein said main body forms an interior volume;
a power supply;
wherein said power supply is located within said interior volume of said main body and is adapted to provide power to said existing watch when connected thereto;
a charging port;
wherein said charging port is attached to said main body and is adapted to releasably attach to a power cable and allow power to transfer therethrough; and
wherein said charging port is electrically attached to said power supply and adapted to allow power to transfer thereto;
a first attachment member;
wherein said first attachment member is attached to said proximal end of said elongated main body, is electrically connected to said power supply, is adapted to releasably attach to a first portion of said existing watch, and is adapted to transfer electric power from said power supply to said existing watch; and
a second attachment member;
wherein said second attachment member is attached to said distal end of said elongated main body, is electrically connected to said power supply, is adapted to releasably attach to a second portion of said existing watch, and is adapted to transfer electric power from said power supply to said existing watch.

2. The wristband of claim 1, wherein said power supply is formed as at least one rechargeable battery.

3. The wristband of claim 2, wherein there are four rechargeable batteries electrically interconnected to one another.

4. The wristband of claim 1, wherein said elongated main body is formed having a C-shape.

5. The wristband of claim 1, further comprising a USB power cable adapted to releasably connect with said charging port and transfer electric power thereto; and wherein said charging port is formed as a USB charging port adapted to releasably receive said USB power cable and allow electric power to transfer from said USB power cable and flow into said power supply.

6. The wristband of claim 1, further comprising an indicator light attached to said main body, is electrically connected to said power supply, and is adapted to alert a user that power is being transferred to said existing watch.

7. The wristband of claim 1, wherein said first attachment member and said second attachment member are formed as releasable lock tabs.

8. An improved smart watch comprising:
a watch member including:
a housing including:
a first portion;
wherein said first portion is adapted to releasably connect with a proximal end of a wristband and allow electric power to pass therethrough;
a second portion;
wherein said second portion is spaced from said first portion and is adapted to releasably connect with a distal end of a wristband and allow electric power to pass therethrough; and
an interior volume;
a time keeping mechanism;
wherein said time keeping mechanism is attached to said housing;
at least one battery member;
wherein said at least one battery member is located within said interior volume of said housing, is electrically connected to said first and second portions, and is electrically connected to said time keeping mechanism; and
a removable wristband comprising:
an elongated main body including:
a proximal end;
a distal end;
a first attachment member;
wherein said first attachment member is located at said proximal end and adapted to releasably attach to said first portion of said watch member;
a second attachment member;
wherein said second attachment member is located at said distal end and adapted to releasably attach to said second portion of said watch member;
wherein said main body forms an interior volume;
a power supply;
wherein said power supply is located within said interior volume of said main body and is adapted to provide power to said battery member of said watch member when connected thereto;
a charging port;
wherein said charging port is attached to said main body and is adapted to releasably attach to a power cable and allow power to transfer therethrough; and
wherein said charging port is electrically attached to said power supply and adapted to allow power to transfer thereto;
wherein said wristband is replaceable by an identical wristband when necessary.

9. The wristband of claim 8, wherein said power supply is formed as at least one rechargeable battery.

10. The wristband of claim 9, wherein there are four rechargeable batteries electrically interconnected to one another.

11. The wristband of claim 8, wherein said elongated main body is formed having a C-shape.

12. The wristband of claim 8, further comprising a USB power cable adapted to releasably connect with said charging port and transfer electric power thereto; and wherein said charging port is formed as a USB charging port adapted to releasably receive said USB power cable and allow electric power to transfer from said USB power cable and flow into said power supply.

13. The wristband of claim 8, further comprising an indicator light attached to said main body, is electrically connected to said power supply, and is adapted to alert a user that power is being transferred to said watch member.

14. The wristband of claim 8, wherein said first attachment member and said second attachment member are formed as releasable lock tabs.

15. The wristband of claim 8, wherein said time keeping mechanism includes a computer processor and a display screen.

16. The wristband of claim 15, wherein said watch member is a smart watch member.

17. The wristband of claim 15, wherein said display screen includes touch-screen technology.
